(19) United States
(12) Patent Application Publication
(10) Pub. No.: US 2024/0426425 A1
(43) Pub. Date: Dec. 26, 2024

(54) CRYOPUMPING-RESISTANT LH2 STORAGE VESSEL

(71) Applicant: CB&ISTS DELAWARE LLC, The Woodlands, TX (US)

(72) Inventors: David CREECH, Glen Ellyn, IL (US); Alexander COOPERMAN, Lisle, IL (US); David BOPP, Montgomery, TX (US)

(21) Appl. No.: 18/748,963

(22) Filed: Jun. 20, 2024

Related U.S. Application Data
(60) Provisional application No. 63/522,652, filed on Jun. 22, 2023.

(51) Int. Cl. F17C 1/12

(52) U.S. Cl. CPC F17C 1/12; F17C 2201/0119; F17C 2203/0329; F17C 2203/0341; F17C 2203/0629; F17C 2221/012; F17C 2223/0161

(57) ABSTRACT

The present disclosure provides liquid gas storage containers and methods thereof. The liquid gas storage container includes an inner shell forming a cavity. The inner shell is disposed on an insulation base. The insulation base includes an insulation sub-layer. The liquid gas storage container includes an outer shell forming an insulation volume between the inner shell and the outer shell. A first insulation layer is disposed within the insulation volume and around the inner shell and the insulation base. A second insulation layer is disposed within the insulation volume between the first insulation layer and the outer shell.

### CROSS-REFERENCE TO RELATED APPLICATIONS

This application claims priority to U.S. Provisional Patent Application Ser. No. 63/522,652, filed on Jun. 22, 2023, which is herein incorporated by reference in its entirety.

### BACKGROUND

### Field

Embodiments of the present disclosure generally relate to a cryogenic vessel for storing liquid hydrogen.

### Description of the Related Art

Hydrogen is an energy source that is an alternative to conventional fossil fuels. For example, some modes of transportation, such as cars, are powered by hydrogen fuel cells. Hydrogen also has applications in other industrial applications, such as the Haber-Bosh process to produce fertilizer. As demand for hydrogen increases, due in part to the development of more efficient hydrogen powered vehicles and machines and consumer adoption thereof, there is a need to store hydrogen in industrial quantities.

Hydrogen gas has a low density. To efficiently store industrial quantities of hydrogen gas, the hydrogen gas is liquefied. However, liquefied hydrogen gas is extremely cold which places stress on its container. For example, the boiling point of liquefied hydrogen gas at one atmosphere of pressure is about −253° C. (20° K). Therefore, liquid hydrogen is typically stored at conditions close to ambient pressure and a temperature of approximately 20 Kelvin.

Storage of liquid hydrogen requires insulation to reduce heat transfer between the liquid hydrogen and the outside environment. Without insulation the liquid hydrogen would rapidly change phase into gaseous hydrogen (commonly referred to as boil-off) and the outside of the storage vessel would be cold enough to liquefy or freeze most components of air such as nitrogen and oxygen.

Liquid hydrogen is sufficiently cold to cause component gases in the air, such as nitrogen or oxygen gas, to condense and freeze in the presence of liquid hydrogen, such as on the walls of the vessel containing the liquid hydrogen. Condensing and freezing of an atmospheric gas transfers heat to the liquid hydrogen which causes the liquid hydrogen to boil-off. The boiled-off hydrogen gas may have to be vented, which results in losses. As a result, some liquid hydrogen containment vessels include a vacuum insulation to avoid heat loads caused by the condensation or freezing of an atmospheric gas.

Conventional liquid hydrogen storage vessels are formed from a double steel walled vessel with a vacuum insulation. The inner steel vessel wall storing the liquid hydrogen is suspended from the outer steel vessel wall. Insulation material is located between two vessel walls in a vacuum condition. With all insulation materials the evacuation of air prevents convection heat transfer and also prevents liquefaction of gases in the insulation space against the cold inner container and the resulting heat transfer that would reduce the insulation effectiveness.

The outer steel vessel walls of the liquid hydrogen storage vessels are limited in size due to the tendency of steel walls to buckle due to the vacuum load of the vacuum insulation. Therefore, the outer container must be designed to withstand the pressure difference caused by evacuating the insulation space, which could cause the outer container to buckle and collapse inwards.

While vacuum-jacketed insulation is cost effective for smaller storage vessels, it can be cost-prohibitive for very large storage vessels to design the outer container for vacuum. Fuel tanks of rockets are often insulated with a single layer of foam due to weight constraints, but they have very high boil-off rates, very short storage time measured in hours, experience adsorption of water vapor and gases that can cause damage to the foam, and the formation of ice on the outside surface. This behavior is not acceptable for multiple fill cycles or long-term storage.

Therefore, what is needed in the art is a method of insulating large liquid hydrogen gas storage vessels which is cost effective.

### SUMMARY

In an aspect, the present disclosure generally provides liquid gas storage containers. The liquid gas storage container includes an inner shell forming a cavity. The inner shell is disposed on an insulation base. The insulation base includes an insulation sub-layer. The liquid gas storage container includes an outer shell forming an insulation volume between the inner shell and the outer shell. A first insulation layer is disposed within the insulation volume and around the inner shell and the insulation base. A second insulation layer is disposed within the insulation volume between the first insulation layer and the outer shell.

In another aspect, the present disclosure generally provides liquid gas storage containers. The liquid gas storage container includes an inner shell forming a cavity. The inner shell is disposed on an insulation base. The insulation base includes an insulation sub-layer. The liquid gas storage container includes an outer shell forming an insulation volume between the inner shell and the outer shell. A first insulation layer is disposed within the insulation volume and around the inner shell and the insulation base. A second insulation layer is disposed within the insulation volume between the first insulation layer and the outer shell. A membrane layer is disposed between the first insulation layer and the second insulation layer.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, may admit to other equally effective embodiments.

FIG. 1 illustrates a schematic cross-sectional side view of a first liquid hydrogen storage container, according to embodiments described herein.

FIG. 2 illustrates a schematic cross-sectional side view of a second liquid hydrogen storage container, according to embodiments described herein.

FIGS. 3A-3C illustrates a schematic cross-sectional side view of exemplary liquid hydrogen storage containers, according to embodiments described herein.

FIGS. 4A-4B illustrate close-up views of a portion of the walls forming the liquid hydrogen storage container, according to embodiments described herein.

FIG. 5 illustrates a close-up view of a portion of the insulation base, according to embodiments described herein.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

The present disclosure generally relates to a cryogenic vessel for storing liquid hydrogen. The present disclosure provides a cryogenic vessel allowing for thinner walls to be utilized, while maintaining efficient cold storage, thereby lowering the cost of the cryogenic vessel. The cryogenic vessel can include an inner shell disposed on an insulation base, the insulation base allowing the cryogenic vessel to implement a flat surface. The insulation base can include a first insulation sub-layer, a leveling layer, and second insulation sub-layer, thereby reducing the thermal conductivity, while providing a stable flat surface for the inner shell to rest on. The insulation base may be enclosed within a skirt and/or anchor straps that supports the weight of an inner shell, thereby reducing foam compression and/or thermal conductivity complications. The skirt can be anchored down to the base, thereby preventing movement of the inner shell within the cryogenic vessel. Advantageously, by anchoring the inner vessel via a skirt and/or anchor straps, lifting of the inner shell within the cryogenic vessel due to internal pressure of the hydrogen acting on the inner shell may be prevented.

The outer insulation layer is filled with gas to maintain the pressure in the insulation space close to the atmospheric pressure outside of the outer vessel such that external pressure on the outer vessel is substantially reduced. This reduces the cost of the outer vessel. As the inner vessel contracts due to the cold liquid hydrogen product, or if the gas condenses, additional gas is supplied to the outer insulation layer to prevent a decrease in pressure. The contraction of the inner vessel may be dependent on the radius of the inner vessel multiplied by the temperature difference between an ambient temperature and the inner vessel temperature. At least one embodiment utilizes a low-thermal conductivity gas such as nitrogen or argon within the insulation space, e.g., inner insulation layer and/or the outer insulation layer.

The insulation layer structure described herein can be used in any application that stores or conveys cryogenic liquids, such as pipes. For example, the insulation layer structure described herein can store liquid helium or liquids with a higher temperature such as liquid natural gas. Spherical liquid gas storage containers are illustrated, however, the insulation layers, membranes, and shell structures described herein may also be used for cylindrical storage containers, or storage containers with other shapes.

When the liquid hydrogen product must be stored at a pressure significantly above ambient pressure the most-straightforward geometry is a sphere, but non-spherical pressure vessel shapes (with generally rounded geometry) are possible. When the liquid hydrogen product can be stored at or near ambient pressure vessels of other shapes, such as a cylinder, may be used. The insulation spaces may have consistent thicknesses throughout to reduce interface temperature variations.

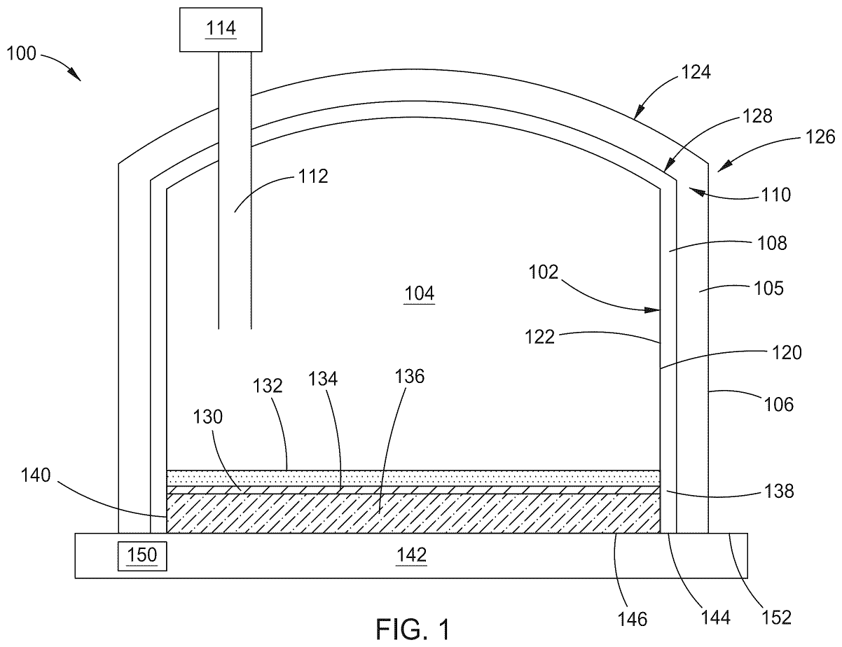

FIG. 1 illustrates a schematic cross-sectional side view of a liquid hydrogen storage container 100. The liquid hydrogen storage container 100 includes an inner shell 102 which forms a cavity 104. The cavity 104 is formed by an inner surface 122 of the inner shell 102. The cavity 104 is configured to hold liquid hydrogen or another liquid gas. The cavity 104 may have a volume of greater than 3,000 m³, such as greater than 4,000 m³, such as greater than 5,000 m³, such as greater than 6,000 m³, such as greater than 6,500 m³, such as greater than 7,000 m³, such as greater than about 10,000 m³, such as greater than about 50,000 m³, such as greater than about 75,000 m³, such as greater than about 100,000 m³, such as greater than about 150,000 m³, such as greater than about 200,000 m³. In some embodiments, the volume is about 5,000 m³ to about 250,000 m³, or greater, such as about 100,000 m³ to about 200,000 m³. The inner shell 102 is formed of a cryogenic metal material, such as a cryogenic steel or another cryogenic metal alloy capable of being utilized at temperatures of about 20 Kelvin. The inner shell 102 may be substantially cylindrical and/or spherical. In some embodiments, the inner shell 102 may be cylindrical having substantially vertical sidewalls, a domed top surface and a flat bottom surface. In some embodiments, the cylindrical inner shell may include rounded corners. Without being bound by theory, rounded corners can provide reduced stress concentration compared to sharp corners, in which rounded corners can provide reduced stress cracking of insulation.

The inner shell 102 is disposed on an insulation base 130. The insulation base can include a first insulation sub-layer 132. The first insulation sub-layer 132 can include a closed cell foam, an open cell foam, or any other load-bearing insulation. The first insulation sub-layer 132 can include an insulation coating, e.g., an aerogel, disposed on the first insulation sub-layer 132 such that the insulation coating is in contact with the interior of the inner shell 102. Without being bound by theory, the insulation coating can improve cryo-adsorption of gas molecules that the vacuum pump did not remove. The first insulation sub-layer 132 is defined laterally by the skirt 138. The first insulation sub-layer 132 is defined horizontally by the leveling layer 134 and/or an interleaving layer.

The first insulation sub-layer 132 is a load-bearing foam, in which the first insulation sub-layer 132 can support about 800 Kpa to about 2,400 Kpa. The first insulation sub-layer 132 is maintained under vacuum, e.g., at pressure of about 1 mTorr to about 1000 mTorr, e.g., about 100 mTorr to about 900 mTorr, about 100 mTorr to about 800 mTorr, or about 500 mTorr to about 700 mTorr. The first insulation sub-layer 132 includes a thickness of about 50 mm to about 1,000 mm, e.g., about 50 mm to about 800 mm, about 100 mm to about 700 mm, or about 200 mm to about 500 mm. The first insulation sub-layer 132 can include thermal expansion coefficient similar to the material of the inner shell 102, in which the first insulation sub-layer 132 can shrink and/or expand at a similar rate to the inner shell 102. Without being bound by theory, the first insulation sub-layer 132 in combination with the vacuum of the first insulation sub-layer 132 can reduce and/or prevent run-away cryopumping by reducing gas liquefaction and/or freezing proximal to the inner shell 102.

The first insulation sub-layer 132 can be disposed on a leveling layer 134. The leveling layer 134 includes a cement material and/or a metal material. The leveling layer 134 includes a thickness of about 0 mm to about 200 mm, e.g., about 10 mm to about 150 mm, about 50 mm to about 150 mm, or about 50 mm to about 100 mm. Without being bound by theory, the leveling layer 134 can provide a uniform and/or flat surface for the first insulation sub-layer 132 to be disposed on, thereby allowing the inner shell 102 to rest on a flat surface.

The leveling layer 134 is disposed on a second insulation sub-layer 136. The leveling layer 134 can include metal, insulation such as an aerogel, and/or concrete. Without being bound by theory, the leveling layer 134 can provide protection of the second insulation sub-layer 136, described below, such that heat is prevented from entering or contacting the second insulation sub-layer 136. For example, the leveling layer 134 can include concrete to prevent heat from interacting with the second insulation sub-layer 136 while welding and/or forming the first insulation sub-layer 132.

The second insulation sub-layer 136 can include a closed cell foam and/or an open cell foam. The second insulation sub-layer 136 is a load-bearing foam, in which the second insulation sub-layer 136 can support about 800 Kpa to about 2,400 Kpa. The second insulation sub-layer 136 includes a thickness of about 200 mm to about 5,000 mm, e.g., about 200 mm to about 4,000 mm, about 500 mm to about 3,000 mm, or about 1,000 mm to about 2,000 mm. The second insulation sub-layer 136 can be filled with a gas, e.g., hydrogen, nitrogen, argon, helium, or a combination thereof. The second insulation sub-layer 136 can be maintained at atmospheric pressure. Without being bound by theory, the second insulation sub-layer 136 can further insulate the insulation base 130, thereby improving cold storage efficiency of the cryogenic vessel.

Optionally, an interleaving layer can be disposed between the first insulation sub-layer 132 and the second insulation sub-layer 136. The interleaving layer can include a composite, cement, metal, polymer, foam, or a combination thereof. The interleaving layer can include a thickness of about 0 mm to about 200 mm, e.g., about 10 mm to about 150 mm, about 50 mm to about 150 mm, or about 50 mm to about 100 mm. Without being bound by theory, the interleaving layer can arrest crack formation and increase strength of the first insulation sub-layer 132 and/or the second insulation sub-layer 136 by preventing crack propagation throughout the insulation base 130.

Optionally, the interleaving layer can include a foam layer. The foam layer can be disposed on and/or over the second insulation sub-layer 136 to form a knitline, e.g., a layer of collapsed foam bubbles. Without being bound by theory, the knitline can reduce permeability due to the increase in the foam density, thereby reducing cryogenic pumping and enhancing cryogenic cooling capabilities.

A skirt 138 is disposed along a sidewall 140 of the insulation base 130. The skirt can support the body of the inner shell 102 and the insulation supported by inner shell 102. The skirt 138 includes a metal material. The skirt 138 includes a thickness of about 5 mm to about 50 mm, e.g., about 5 mm to about 40 mm, about 10 mm to about 40 mm, or about 20 mm to about 30 mm. Without being bound by theory, the skirt 138 can provide structural support for the insulation base 130, thereby providing support against the vacuum pressure in the radial direction. The skirt 138 can be mechanically coupled, e.g., fastened, to a base 142 via one or more anchors 144. The one or more anchors 144 may be embedded in an upper surface 146 of the base 142. Additionally, or alternatively, the anchors 144 can extend from the upper surface 146 to the skirt 138 (not shown). The base can include a cement material and/or a metal material. The base 142 can include one or more heating elements 150. Without being bound by theory, the one or more heating elements 150 can reduce and/or prevent freezing of a material disposed below the base 142, thereby preventing damage to the base 142.

The one or more anchors 144 can allow the skirt 138 to be mounted to the base 142 such that the inner shell 102 does not move and/or shift within the liquid hydrogen storage container 100, thereby preventing the insulation volume from becoming compromised. The one or more anchors 144 can include a fastener, a strap, a bolt, a nut, a rivet, or a combination thereof. The one or more anchors can include cryogenic steel, stainless steel, and/or a combination thereof. The one or more anchors 144 can extend along the length of the skirt 138 and/or be disposed along an upper surface 146 of the base 142. Without being bound by theory, by anchoring the skirt 138 to the base 142 via an anchor 144 disposed along an upper surface 146 of the base 142, the inner shell 102 may be prevented from lifting off the insulation base 130 after a seismic acceleration and/or internal pressure load.

An outer shell 106 is formed around the inner shell 102 and the skirt 138. An insulation volume 105 is formed between the inner shell 102 and the outer shell 106. The insulation volume 105 includes at least two insulation layers, such as a first insulation layer 108 and a second insulation layer 110. The first insulation layer 108 is disposed proximal to the inner shell 102 and proximal to the skirt 138, such that the first insulation layer 108 covers an outer surface 120 of the inner shell 102 and the skirt 138. In some embodiments, the first insulation layer 108 can form a coating around the inner shell 102 and the skirt 138 such that the inner shell 102 and skirt 138 is encapsulated. The first insulation layer 108 is attached to the outer surface 120 of the inner shell 102 and the skirt 138. The first insulation layer 108 is chemically bonded to the outer surface 120, in which the chemical bond can include forming a bond using an epoxy bond and/or forming a bond via a reaction between the first insulation layer 108 and the outer surface 120. The first insulation layer 108 is a closed-cell insulation material. Closed-cell foams include polyethylene, polyurethane, polyisocyanurate, and polystyrene foams.

Closed-cell foams are formed by cells that have thin polymeric membranes arranged in polyhedral shapes, e.g., about 0.01 mm to about 1.0 mm, such as about 0.01 mm to about 0.5 mm, about 0.05 mm to about 0.1 mm, or about 0.07 to about 0.1 mm. The cells are filled with gas such as a blowing agent, which is a gas that is used to expand the cells in the foam. For example, a blowing agent can include an unsaturated organic compound such as hydrofluoroolefin. At room temperature atmospheric gases, such as nitrogen, can diffuse into the cells, in which the blowing agent diffuses out.

When the outer surface 120 of the inner shell is cooled down, gases in the cells of the first insulation layer 108 proximal to the outer surface 120, and/or the skirt 138, also cool. The gases can liquefy and/or solidify. When the gases liquefy and/or solidify, the pressure in the cell drops, creating a pressure difference across the cell wall of the closed-cell foam. The pressure differential can be about 0.01 atm to about 1 atm, e.g., about 0.01 atm to about 0.5 atm, about 0.01 atm to about 0.1 atm, or about 0.01 atm to about 0.05 atm. When the cell wall of the closed-cell foam is permeable to gases, the gas will diffuse from surrounding cells with higher pressure into the cell with low pressure, and can liquefy. This process can continue until the cells proximal to the outer surface 120 are substantially filled with liquefied and/or frozen gases. Upon warming of the outer surface 120, such as during maintenance, the liquefied and/or solidified gases will vaporize, and can rupture the cells.

To prevent damage the closed-cell foam can be cooled to cryogenic temperatures, thereby reducing and/or preventing diffusion of gases into a cell of the closed-cell foam due to reduced permeability of the closed-cell foam. Without being bound by theory, by reducing permeability of the closed-cell foam the likelihood of rupture when warming the closed-cell foam is reduced. Moreover, and without being bound by theory, the first insulation layer 108 can reduce complications of insulation performance damage upon warming the inner shell 102.

The first insulation layer 108 is filled with a first gas, such as a blowing agent, nitrogen or a nitrogen containing mixed gas. For example, the first insulation layer 108 can initially be filled with a first gas of hydrofluoroolefin, in which after a period of time, e.g., seconds, minutes, hours, days, years, or decades, the first insulation layer 108 can be filled with a second gas of nitrogen. In some examples, the first insulation layer 108 may be filled with air with concentrations similar to those found in ambient air. The first insulation layer 108 is used adjacent to the inner shell 102 and the first insulation layer 108 is thick enough so the temperature at the outer surface 128 of the first insulation layer 108 is above 77 Kelvin (the point at which nitrogen boils or liquefies).

The closed-cell insulation material which forms the first insulation layer 108 has a cell size (diameter) of less than about 1 μm to about 1 cm, such as 0.1 mm to about 1.0 mm. The first insulation layer 108 has a first conductivity of about 0.0001 W/(m·K) to about 0.050 W/(m·K), such as about 0.010 W/(m·K) to about 0.040 W/(m·K), such as about 0.010 W/(m·K) to about 0.030 W/(m·K), such as about 0.015 W/(m·K) to about 0.030 W/(m·K), such as about 0.020 W/(m·K) to about 0.030 W/(m·K).

A second insulation layer 110 is also disposed within the insulation volume 105. The second insulation layer 110 is disposed between the first insulation layer 108 and the outer shell 106. The second insulation layer 110 is disposed on an outer surface 128 of the first insulation layer 108 and inside of an inner surface 124 of the outer shell 106. The cross-section of the inner surface 124 of the outer shell 106 may be circular and/or cylindrical. The second insulation layer 110 has a thermal conductivity, which is optionally higher than the thermal conductivity of the first insulation layer 108. The second insulation layer 110 may be formed from a bulk material, e.g., a gas, foam, fiberglass, aerogel, expanded perlite, glass microspheres, an insulation with low thermal conductivity, and/or a combination thereof. For example, the second insulation layer 110 can include a gas. As a further example, the second insulation layer 110 can include a mixture of a fiberglass, glass microspheres, and perlite. As a further example, the second insulation layer 110 can include expanded perlite. The glass microspheres can include a diameter of about 1 nm to about 100 μm, e.g., about 1 nm to about 10 μm, about 500 nm to about 10 μm, or about 500 nm to about 1 μm. The second insulation layer 100 may be a closed-cell foam. Without being bound by theory, a second insulation layer 110 including a mixture of fiberglass, glass microspheres, and perlite can prevent movement of the glass microspheres and perlite within the insulation layer due to the fiberglass restraining and/or holding the glass microspheres and/or perlite in place.

In at least an embodiment, the second insulation layer 110 can include perlite having a flow permeability of about 40 Darcy to about 50 Darcy. In at least an embodiment, the second insulation layer 110 can include glass microspheres having a flow permeability of about 3 Darcy to about 10 Darcy. In at least an embodiment, the second insulation layer 110 can include a mixture of perlite and glass microspheres. The mixture can include about 1 wt % to about 99 wt % of perlite and about 1 wt % to about 99 wt % of glass microspheres. For example, the mixture can include about 60 wt % to about 99 wt % of perlite and about 1 wt % to about 40 wt % of glass microspheres. As a further example, the mixture can include about 80 wt % to about 99 wt % of perlite and about 1 wt % to about 20 wt % glass microspheres. The mixture can include a flow permeability of about 6 Darcy to about 45 Darcy, e.g., about 6 Darcy to about 40 Darcy, about 6 Darcy to about 30 Darcy, about 6 Darcy to about 20 Darcy, or about 10 Darcy to about 20 Darcy. Without being bound by theory, a second insulation layer having a flow permeability of about 6 Darcy to about 40 Darcy can reduce run-away cryopumping, thereby increasing efficiency of temperature insulation of the second insulation layer 110.

The second insulation layer 110 is filled with a second gas, which may be a single gas or a combination of gases combination. The second gas may be over 50% nitrogen, over 50% argon, or over 50% of a combination of nitrogen and argon when measured by partial pressures. In some embodiments, the second gas combination may be over 60% of one or a combination of nitrogen and argon, such as over 70% of one or a combination of nitrogen and argon, such as over 80% of one or a combination of nitrogen and argon, such as over 90% of one or a combination of nitrogen and argon. The nitrogen and/or argon concentration within the first insulation layer 108 may be maintained by exposing the first insulation layer 108 to a nitrogen and/or argon gas source. In some examples, dry air may be utilized. A nitrogen and/or argon gas may be used in the second insulation layer 110 during formation of the second insulation layer 110 onto the outer surface 128 of the first insulation layer 108.

The hydrogen or helium gas concentrations are reduced within the second insulation layer 110 due to the highly conductive qualities of hydrogen and helium compared to nitrogen and argon.

The second insulation layer 110 has a second conductivity of about 0.010 W/(m·K), to about 0.100 W/(m·K). The thermal conductivity of the first insulation layer 108 may be 2 times less than the thermal conductivity of the second insulation layer 110, such as 3 times less than the thermal conductivity of the second insulation layer 110, such as 4 times less than the thermal conductivity of the second insulation layer 110, such as 5 times less than the thermal conductivity of the second insulation layer 110, such as 7 times less than the thermal conductivity of the second insulation layer 110, such as 10 times less than the thermal conductivity of the second insulation layer 110.

At least two insulation layers are disposed between the inner shell 102 and the outer shell 106, e.g., within the insulation volume 105. There is a first insulation layer 108 which may be a closed-cell foam, which can prevent run-away cryopumping. There is also a second insulation layer 110 suitable to reduce manufacturing costs and a supply of gas to maintain a pressure within the outer insulation layer. The gas in the second insulation layer 110 is a gas or mixture of gases with relatively low conductivity that would liquefy at liquid hydrogen temperatures of around 20 K. The temperature of the outer edge of the first insulation layer is above the condensation temperature of the gas or mixture of gases in the second insulation layer to prevent condensation and run-away cryopumping. The pressure is maintained substantially above full vacuum to reduce cost of the outer vessel. The pressure within the second insulation layer 110 is maintained at about 0.5 atmospheres to about 2 atmospheres, such as about 0.5 atmospheres to about 1.5 atmospheres, such as about 0.75 atmospheres to about 1.25 atmospheres, such as about 0.8 atmospheres to about 1.2 atmospheres, such as about 0.9 atmospheres to about 1.1 atmospheres, such as about 0.95 atmospheres to about 1.05 atmospheres, such as at about 1 atmosphere. The pressures within the first insulation layer 108 may be about 1.0 atmospheres at a first surface thereof, but reduces in pressure to about 0.2 atmosphere or less, to about 0.1 atmosphere or less, near the inner shell 102.

Optionally, an interleaving layer can be disposed between the first insulation layer 108 and the second insulation layer 110. The interleaving layer can include a composite, cement, metal, polymer, foam, or a combination thereof. The interleaving layer can include a thickness of about 0 mm to about 200 mm, e.g., about 10 mm to about 150 mm, about 50 mm to about 150 mm, or about 50 mm to about 100 mm. Without being bound by theory, the interleaving layer can arrest crack formation and increase strength of the first insulation layer 108 and/or the second insulation layer 110 by preventing crack propagation throughout the insulation volume 105.

Optionally, the interleaving layer can include a foam layer. The foam layer can be disposed on and/or over the second insulation layer 110 to form a knitline, e.g., a layer of collapsed foam bubbles. Without being bound by theory, the knitline can reduce permeability due to the increase in the foam density, thereby reducing cryogenic pumping and enhancing cryogenic cooling capabilities.

A conduit 112 extends into the cavity 104 and through each of the inner shell 102, the first insulation layer 108, the second insulation layer 110, and the outer shell 106. The conduit 112 may be a pipe or a tube which extends into the cavity 104 in order to either fill or drain the cavity 104 of liquid hydrogen. The conduit 112 is disposed such that an open end of the conduit 112 is within the cavity 104 while another end of the conduit 112 is connected to a hydrogen source 114 outside of the body of the liquid hydrogen storage container 100. The hydrogen source 114 may include a pump or a condenser as well as one or more feed lines to various other hydrogen sources. While only a single conduit is shown, it is to be understood than more than one conduit may be included, such as a conduit for filling, one for withdrawal, one for venting boil-off gas, and optionally other conduits. In some examples, the filling and boil off conduits through the top, while the withdrawal line may be through the top or bottom. Other configurations are also contemplated.

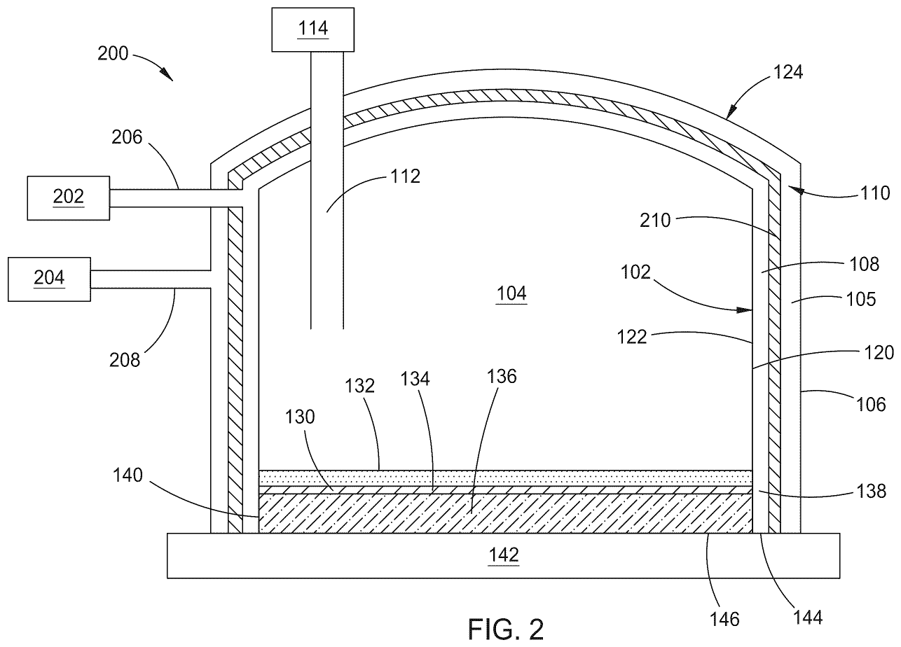

FIG. 2 illustrates a schematic cross-sectional side view of another liquid hydrogen storage container 200. The liquid hydrogen storage container 200 includes an intermediate shell 210. The intermediate shell 210 may be an impermeable membrane, such as metallic or non-metallic, depending upon the embodiment and the types of insulation utilized in one or both of the first insulation layer 108 and the second insulation layer 110. In some examples, when using an impermeable membrane as the intermediate shell, a closed cell foam and/or an open cell foam may be used as the first insulation layer 108.

The intermediate shell 210 is an impermeable membrane, such that gases or liquid do not pass through the intermediate shell 210, but the intermediate shell 210 is still capable of flexing and bending to maintain contact with both of the first insulation layer 108 and the second insulation layer 110. The intermediate shell 210 may be impermeable at a temperature of about 50 Kelvin to about 100 Kelvin, such as about 60 Kelvin to about 90 Kelvin, such as about 70 Kelvin to about 90 Kelvin, such as about 75 Kelvin to about 85 Kelvin. The intermediate shell 210 is impermeable at least in part because the coefficient of permeability is sufficiently low to provide a predetermined level of impermeability for use of the storage vessel. Without being bound by theory, the coefficient of permeability may be low enough to prevent and/or reduce damage to the first insulation layer when the tank is warmed during maintenance and/or when not in operation of cryogenic cooling.

In embodiments wherein the intermediate shell 210 is an impermeable membrane, the membrane layer may be one or a combination of epoxy, polyethylene terephthalate (Mylar), aluminized polyethylene terephthalate, polypropylene, polyimide, polyetherimide, polyether ether ketone, or various metal foils. Other materials are also contemplated, but not listed explicitly herein. The membrane may have a modulus of elasticity of greater than 400 kg/mm², such as greater than 500 kg/mm², such as greater than 600 kg/mm², such as greater than 700 kg/mm² at a temperature of about 77 Kelvin. The modulus of elasticity allows the membrane to flex along with the first insulation layer 108 and the second insulation layer 110 as the first insulation layer 108 and/or the inner shell 102 shrinks and expands during cooling and heating of the first insulation layer 108 and the inner shell 102. The membrane also helps seal the first insulation layer 108 from the second insulation layer 110. Therefore, if there are any gaps or cracks within the first insulation layer 108, the effects of cryo-pumping may be reduced or eliminated by the presence of the membrane. The use of an intermediate shell 210 which is a flexible membrane may further enable additional materials to be utilized as part of the first insulation layer 108, such as open-cell foam.

Optionally, there is also a sealant disposed around any opening within the intermediate shell 210, such that there is no fluid communication between the first insulation layer 108 and the second insulation layer 110 even where something passes through the intermediate shell 210, such as the support skirt 118. The sealant can include an epoxy resin such as LOCTITE® Stycast 2850. The sealant can include a diphenol resin, such as epichlorohydrin-4,4′-isopropylidene. The sealant must be capable of providing a seal at a temperature of less than 100 Kelvin.

Optionally, a collar can be welded to the skirt, piping, and/or supports that penetrate the first insulation layer. The collar can include a membrane chemically bonded to an outer surface of the collar and the first insulation layer. Without being bound by theory, by welding a collar having a membrane to the skirt, piping, and/or supports that penetrate the first insulation layer the cryogenic cooling capability of the cryogenic vessel may be enhanced.

The intermediate shell 210 may also be referred to as a middle membrane, and is disposed between the first insulation layer 108 and the second insulation layer 110. In such an example, the intermediate shell 210 may be a metal, a polymer, or a combination thereof.

An intermediate shell 210 may be formed of a material which is not self-supporting, or is otherwise flexible. The first insulation layer 108 may be self-supporting when the intermediate shell 210 is an impermeable membrane. In such an example, the first insulation layer 108 has sufficient structural rigidity to support pressures exerted by the gas in the second insulation layer 110. Spray-on foam and aerogel blankets may be examples of self-supporting materials which can be used in the first insulation layer 108. The insulation material of the first insulation layer 108 may include a compressive strength of about 14 psi to about 100 psi, e.g., about 14 psi to about 90 psi, about 20 psi to about 80 psi, or about 30 psi to about 70 psi, to support the loads transmitted through the impermeable membrane from both the differential pressure and any forces exerted by granular materials used for insulation in the second insulation layer 110.

The liquid hydrogen storage container 200 can include one or more gas inputs, e.g., a first gas source 202 and a second gas source 204, and one or more pumps or compressors in fluid communication with the second insulation layer. In some examples, the one or more gas inputs and one or more pumps are part of or function as a pressure regulator. The one or more pumps or compressors which may be fluidly coupled to the first insulation layer 108 assist in maintaining a predetermined pressure within the first insulation layer 108. Liquefaction or freezing of the gases within the first insulation layer 108 create a vacuum (e.g., a pressure below atmospheric pressure), which may vary in absolute value from cell to cell, or be present in a non-linear gradient from one surface to the opposite surface. During operation, pressures within the cells of the foam of the first insulation layer are allowed to reach a predetermined level of vacuum (e.g., sub-atmospheric pressure), providing beneficial thermal conductivity within the cells. For example, a first gas source 202 may be fluidly coupled to the first insulation layer 108 via first conduit 206, and a second gas source 204 is fluidly coupled to the second insulation layer 110 through a conduit 208. The second gas source 204 may be similar to the first gas source 202 in that it may include one or more pumps, compressors, or connections to one or more other fluid delivery systems. When using a first gas source, the first insulation layer 108 and the second insulation layer 110 may receive different gases from different gas sources.

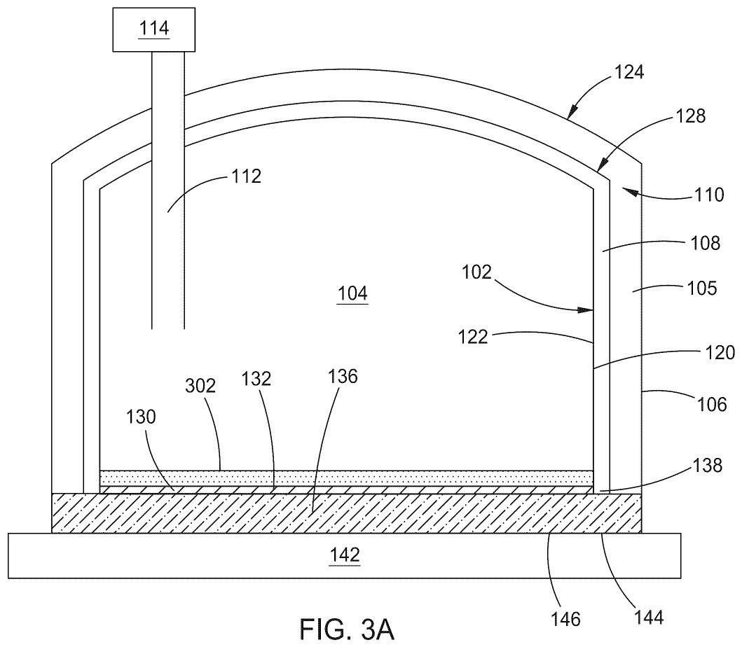

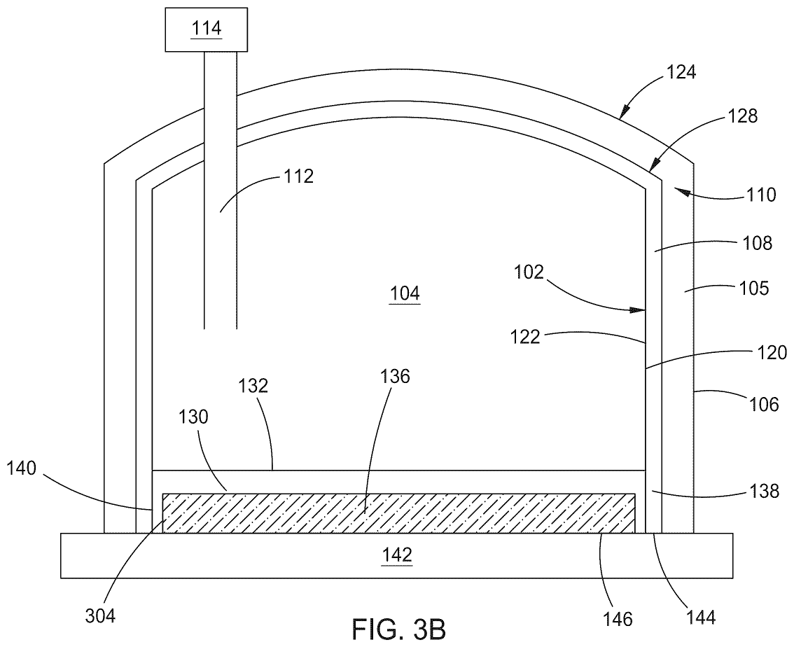

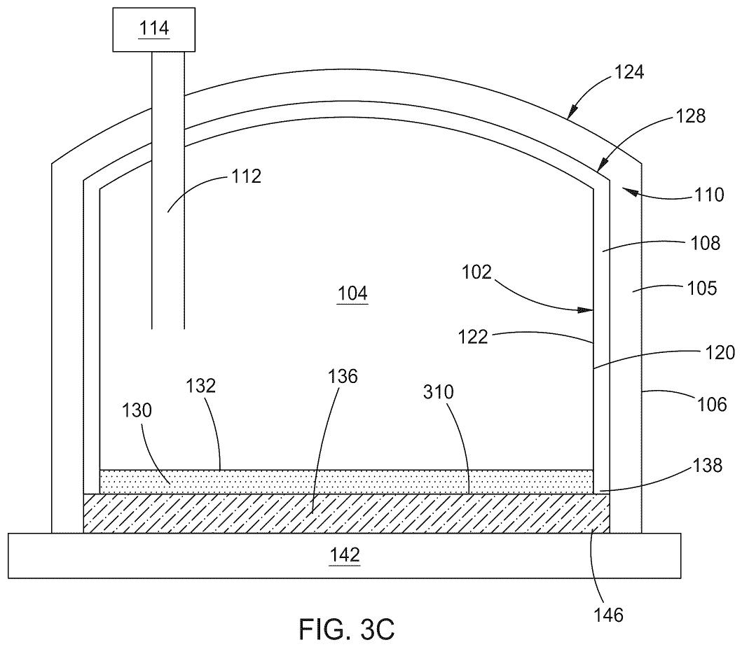

As shown in FIG. 3A, the second insulation sub-layer 136 can extend along the base 142 such that the inner shell 102 and the outer shell 106 are disposed on the second insulation sub-layer 136. The second insulation sub-layer 136 can be exposed to the first insulation layer 108 and/or the second insulation layer 110. The one or more anchors 144 can extend through the second insulation sub-layer 136, thereby preventing gas leaks and subsequent condensation and/or freezing of the one or more anchors.

A protective layer 302 is disposed on the first insulation sub-layer 132. The protective layer 302 can include a metal layer, a cement layer, a polymer layer, and/or other suitable material to protect the first insulation sub-layer 132 from heat. Without being bound by theory, the protective layer 302 can protect the first insulation sub-layer 132 from heat while manufacturing the inner shell 102, thereby preventing cracks and/or deformations during manufacturing.

As shown in FIG. 3B, the first insulation sub-layer 132 can be disposed on the second insulation sub-layer 136, in which the first insulation sub-layer 132 contacts the skirt 138 and a sidewall 304 of the second insulation sub-layer 136. The first insulation sub-layer 132 includes the insulation of the first insulation layer 108, described herein. Without being bound by theory, by having the first insulation sub-layer disposed along the skirt 138 and the sidewall of the second insulation sub-layer, a reduction of gaps between the skirt and the first insulation sub-layer can occur. Additionally, and without being bound by theory, a reduction of cracking at a bottom corner of the inner shell 102 may occur.

As shown in FIG. 3C, the second insulation sub-layer 136 can extend along the base 142 such that the inner shell 102 is disposed on the second insulation sub-layer 136. The second insulation sub-layer 136 can be exposed to the first insulation layer 108, in which the skirt 138 ends on a top surface 310 of the second insulation sub-layer 136. The first insulation sub-layer 132 can include the insulation of the first insulation layer 108, described herein. Without being bound by theory, a reduction of heat leakage occurs due to the skirt ending on a top surface of the second insulation sub-layer.

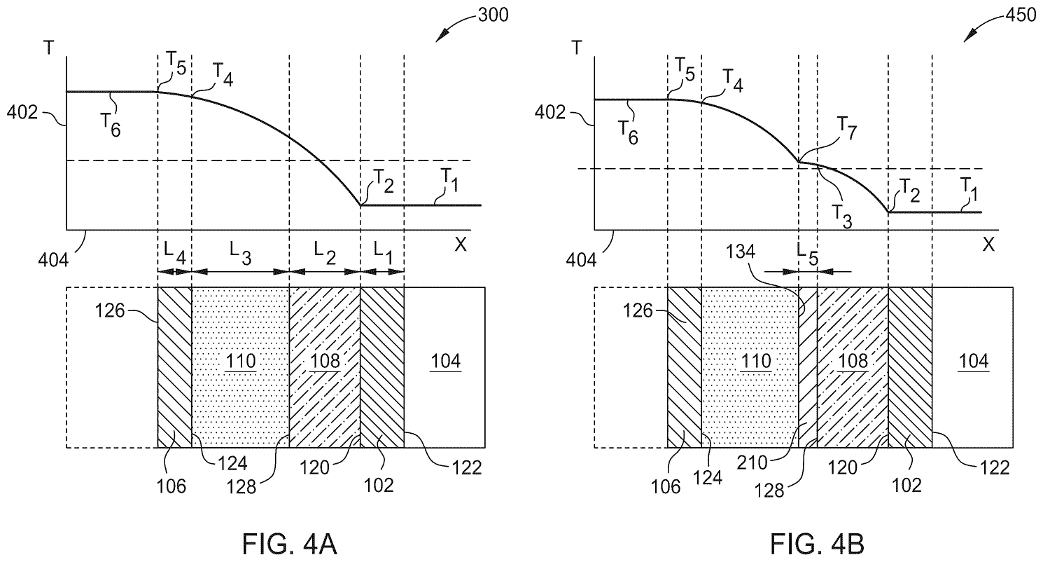

FIG. 4A illustrates a close-up view of a portion of the walls forming the liquid hydrogen storage container 100 of FIG. 1. Above the portion of the liquid hydrogen storage container 100 is a graph 400 illustrating a schematic of the temperature of the liquid hydrogen storage container 100 at various points within the body of the liquid hydrogen storage container 100. The graph 400 includes a vertical axis 402 which illustrates the temperature (T) and a horizontal axis 404 which illustrates the position within the liquid hydrogen storage container 100 relative to a center of the cavity 104.

The cavity 104 is maintained at a first temperature T₁. The first temperature T₁ is below the boiling point of the gas within the cavity 104. Therefore, the first temperature T₁ is at or below about 20 Kelvin while storing liquid hydrogen. The temperature rises to a second temperature T₂ within the inner shell 102. The second temperature T₂ may be fairly similar to the first temperature T₁, such as about 20 Kelvin to about 25 Kelvin, such as about 20 Kelvin to about 22 Kelvin. In some examples, the deference between the first temperature T₁ and the second Temperature T₂ is less than 2 Kelvin, such as less than 1 Kelvin, such as less than 0.5 Kelvin. The second temperature T₂ can be directly related to the first thickness L₁ of the inner shell 102. The first thickness L₁ is about 10 mm to about 100 mm, such as about 10 mm to about 75 mm, such as about 10 mm to about 50 mm, such as about 15 mm to about 45 mm, such as about 20 mm to about 45 mm, such as about 20 mm to about 30 mm.

The temperature rises through the first insulation layer 108 from the second temperature T₂ to a third temperature T₃. The third temperature T₃ is above the condensation point of the gases within the second insulation layer 110, such as above the condensation point of nitrogen or argon. The third temperature T₃ may be above the condensation point of the gases within the second insulation layer 110 by less than about 20 Kelvin, about 10 Kelvin, such as by less than about 5 Kelvin. When the gas within the second insulation layer 110 is nitrogen, the third temperature T₃ is above 77 Kelvin, such as about 78 Kelvin to about 80 Kelvin, such as about 78 Kelvin to about 90 Kelvin, such as about 78 Kelvin to about 100 Kelvin. In other examples, the third temperature T₃ may be as high as 150K to 170K, to further reduce the likelihood of condensation.

To reach a temperature of above 77 Kelvin, the first insulation layer 108 has a thickness L₂ of about 0.1 meters to about 1 meters, such as about 0.55 meters to about 0.75 meters, such as about 1 meter to about 1.5 meters, such as about 1.1 meters to about 1.4 meters, such as about 1.2 meters to about 1.3 meters. The total thickness of both of the insulation layers, combined, is within a range of about 0.2 meters to about 5 meters, such as 1 meter to 3 meters, such that construction, transportation, and maintenance are made easier and cheaper. The relative thicknesses of the insulation layers is selected to achieve a predetermined temperature T₃, while the total thickness (and conductivity) of the first insulation layer 108 and the second insulation layer 110 are selected to provide a predetermined amount (or lack thereof) of leakage/boil off rate.

As the second insulation layer 110 extends from the outer surface 128 of the first insulation layer 108 to the inner surface 124 of the outer shell 106, the temperature rises until the temperature reaches a fourth temperature T₄. The fourth temperature is between the third temperature T₃ and an ambient temperature T₆ surrounding the outer surface 126 of the outer shell 106. The fourth temperature T₄ may therefore be about 80 Kelvin to about 320 Kelvin, such as about 100 Kelvin to about 315 Kelvin, such as about 200 Kelvin to about 310 Kelvin, such as about 250 Kelvin to about 310 Kelvin, such as about 273 Kelvin to about 310 Kelvin. In one example, the fourth temperature T₄ is within about 2-5 Kelvin of the ambient temperature T₆. The second insulation layer has a third thickness L₃. The third thickness L₃ is as noted above.

As the outer shell 106 extends from the inner surface 124 to the outer surface 126, the temperature within the outer shell 106 rises from the fourth temperature T₄ to a fifth temperature T₅. The fifth temperature T₅ is close to an ambient temperature T₆ of the environment surrounding the outer shell 106, such as about 250 Kelvin to about 315 Kelvin, such as about 265 Kelvin to about 310 Kelvin, such as about 273 Kelvin to about 305 Kelvin. The thickness of the outer shell 106 is a fourth thickness L₄. The fourth thickness L₄ is less than the first thickness L₁ of the inner shell 102 because the inner shell 102 has the pressurized cavity 104 formed by the inner surface 122. The outer shell 106 enables for general support and protection of the insulation layers. However, it is contemplated that the thickness L₄ could be greater in some circumstances, where extra protection of the insulation and/or contents is desired. The fourth thickness L₄ is about 10 mm to about 100 mm, such as about 10 mm to about 10 mm to about 50 mm, such as about 10 mm to about 30 mm, such as about 14 mm to about 25 mm, such as about 15 mm to about 20 mm.

FIG. 4B illustrates a close-up view of a portion of the walls forming the liquid hydrogen storage container 200 of FIG. 2. Above the portion of the liquid hydrogen storage container 200 is a graph 450 illustrating a schematic of the temperature of the liquid hydrogen storage container 200 at various points within the body of the liquid hydrogen storage container 200. The graph 450 is similar to the graph 400 of FIG. 4A, but further includes a portion which corresponds to the temperature gradient within the intermediate shell 210. The temperature within the intermediate shell 210 is from the third temperature T₃ to a seventh temperature T₇. The seventh temperature may be substantially the same as the third temperature T₃ or just above the third temperature T₃, such as about 0 Kelvin to about 3 Kelvin above the third temperature T₃.

The intermediate shell 210 has a fifth thickness L₅ of about 10 mm to about 100 mm, such as about 10 mm to about 75 mm, such as about 10 mm to about 50 mm, such as about 15 mm to about 45 mm, such as about 20 mm to about 45 mm, such as about 20 mm to about 30 mm. The fifth thickness L₅ is between the first thickness L₁ and the fourth thickness L₄. However, other thicknesses and/or relative thickness are also contemplated.

The embodiments described herein enable a better and more reliable apparatus for insulating liquid gas storage containers, such as liquid hydrogen storage containers. The embodiments described herein are more economic and easier to manufacture. Disclosed embodiments reduce cryopumping within the first insulation layer 108 by using closed-cells with reduced gaseous diffusion through the first insulation layer 108. The second insulation layer 110 can be a thermal insulator due to the use of the mixture of glass microspheres and perlite, thereby increasing insulation capabilities compared to conventional insulation devices. While the present disclosure shows the mixture of glass microspheres and perlite in the system 100, the mixture of glass microspheres and perlite can be implemented in any system suitable for insulating one or more temperatures. For example, the mixture of glass microspheres and perlite can be implanted in a spherical system.

Some embodiments, which can be combined with other embodiments, utilize an additional intermediate shell 210 (e.g., membrane) between the first insulation layer 108 and the second insulation layer 110. The intermediate shell 210 may be an impermeable membrane which can flex to accommodate changes in dimension of the first insulation layer 108 or a metal/metal alloy shell. The impermeable membrane can further reduce the likelihood for cryopumping.

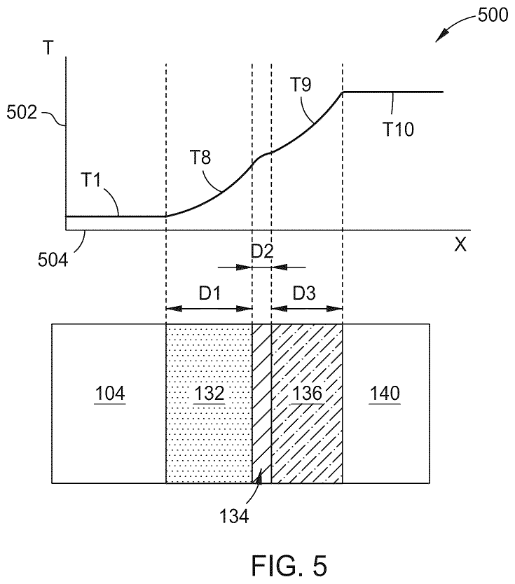

FIG. 5 illustrates a close-up view of a portion of the insulation base 130 of the liquid hydrogen storage container. Above the portion of the liquid hydrogen storage container is a graph 500 illustrating a schematic of the temperature of the liquid hydrogen storage container at various points within the body of the liquid hydrogen storage container. The graph 500 includes a vertical axis 502, illustrating the height (x) within the liquid hydrogen storage container relative to a center of the cavity and a horizontal axis 504, which illustrates the temperature (T).

The cavity 104 is maintained at a first temperature T₁. The first temperature T₁ is below the boiling point of the gas within the cavity 104. Therefore, the first temperature T₁ is at or below about 20 Kelvin while storing liquid hydrogen. The temperature rises through the first insulation sub-layer 132 from the first temperature T₁ to a second temperature T₈. The second temperature T₈ is above the condensation point of the gases within the second insulation sub-layer 136, such as above the condensation point of nitrogen or argon. The second temperature T₈ may be above the condensation point of the gases within the second insulation sub-layer 136 by less than about 10, such as by less than about 5. For example, the second temperature T₈ is above 77 Kelvin, such as about 78 Kelvin to about 80 Kelvin, such as about 78 Kelvin to about 90 Kelvin, such as about 78 Kelvin to about 100 Kelvin. As a further example, the second temperature T₈ may be as high as 150K to 170K, to further reduce the likelihood of condensation. Optionally, where the thickness of the first insulation sub-layer 132 is greater than the thickness of the second insulation sub-layer 136, the second temperature T₈ may be about 90% to about 100% relative to the third temperature T₁.

The first insulation sub-layer 132 has a thickness D₁ of about 50 mm millimeters (mm) to about 5000 mm, e.g., about 50 mm to about 4000 m, about 80 mm to about 3000 mm, or about 100 mm to about 1000 m.

The temperature may remain steady at the leveling layer 134. The leveling layer 134 has second thickness D₂ of about 0 mm to about 200 mm, e.g., about 0 mm to about 180 mm, about 10 mm to about 150 mm, or about 20 mm to about 100 mm. The temperature may continue to rise until it reaches a third temperature, T₉. The third temperature is between the second temperature T₈ and a T₁ surrounding the second insulation sub-layer 136, e.g., at the base 142. The third temperature T₉ may therefore be about 80 Kelvin to about 320 Kelvin, such as about 100 Kelvin to about 315 Kelvin, such as about 200 Kelvin to about 310 Kelvin, such as about 250 Kelvin to about 310 Kelvin. In one example, the third temperature T₉ is within about 2-5 Kelvin of the temperature T₁. The temperature T₁ may be above freezing and/or ambient temperature. The second insulation sub-layer 136 has a third thickness D₃. The third thickness D₃ is from about 200 mm to about 5000 mm, e.g., about 200 mm to about 4000 mm, about 500 mm to about 3000 mm, or about 1000 mm to about 2000 mm.

The total thickness of the insulation base 130 is about 1000 mm to about 5000 mm, such as 1000 mm to 3000 mm, such that construction, transportation, and maintenance are made easier and cheaper. The relative thicknesses of the first insulation sub-layer 132, the leveling layer 134, and the second insulation sub-layer 136 may provide a predetermined amount (or lack thereof) of leakage/boil off rate.

Overall, the present disclosure provides a cryogenic vessel allowing for thinner walls to be utilized, while maintaining efficient cold storage, thereby lowering the cost of the cryogenic vessel. The cryogenic vessel can include an inner shell disposed on an insulation base, the insulation base allowing the cryogenic vessel to implement a flat surface. The insulation base can include a first insulation sub-layer, a leveling layer, and second insulation sub-layer, thereby reducing the thermal conductivity, while providing a stable flat surface for the inner shell to rest on. The insulation base may be enclosed within a skirt that supports the weight of an inner shell, thereby reducing foam compression and/or thermal conductivity complications. The skirt can be anchored down, thereby preventing movement of the inner shell within the cryogenic vessel.

While the foregoing is directed to embodiments of the present disclosure, other and further embodiments of the disclosure may be devised without departing from the basic scope thereof, and the scope thereof is determined by the claims that follow.

What is claimed is:

1. A liquid gas storage container comprising:
an inner shell forming a cavity, the inner shell disposed on an insulation base, the insulation base comprising a first insulation sub-layer;
an outer shell forming an insulation volume between the inner shell and the outer shell;
a first insulation layer disposed within the insulation volume and around the inner shell and the insulation base; and
a second insulation layer disposed within the insulation volume between the first insulation layer and the outer shell.

2. The liquid gas storage container of claim 1, further comprising a skirt disposed along a sidewall of the insulation base.

3. The liquid gas storage container of claim 2, wherein the first insulation layer is disposed within the insulation volume and around the skirt.

4. The liquid gas storage container of claim 3, further comprising one or more anchors mechanically coupled to the skirt.

5. The liquid gas storage container of claim 1, wherein the first insulation sub-layer comprises a pressure of about 100 mTorr to about 1000 mTorr.

6. The liquid gas storage container of claim 1, wherein the first insulation sub-layer comprises a load-bearing insulation.

7. The liquid gas storage container of claim 6, wherein the first insulation sub-layer comprises a load-bearing foam comprising a closed-cell foam.

8. The liquid gas storage container of claim 1, further comprising an interleaving layer disposed between:
the first insulation sub-layer and a second insulation sub-layer; or
the first insulation layer and the second insulation layer.

9. The liquid gas storage container of claim 1, further comprising a protective layer disposed on the first insulation sub-layer.

10. The liquid gas storage container of claim 1, wherein the second insulation layer comprises a bulk fill material.

11. The liquid gas storage container of claim 10, wherein the bulk fill material comprises one or more of perlite, glass microspheres, fiberglass, or a mixture thereof.

12. The liquid gas storage container of claim 11, wherein the mixture comprises about 60 wt % to about 99 wt % perlite and about 1 wt % to about 40 wt % glass microspheres.

13. A liquid gas storage container comprising:
an inner shell forming a cavity, the inner shell disposed on an insulation base, the insulation base comprising a first insulation sub-layer;
an outer shell forming an insulation volume between the inner shell and the outer shell;
a first insulation layer disposed within the insulation volume and around the inner shell and the insulation base; and
a second insulation layer disposed within the insulation volume between the first insulation layer and the outer shell; and
a membrane layer disposed between the first insulation layer and the second insulation layer.

14. The liquid gas storage container of claim 13, wherein the membrane layer comprises one or more of an aluminized Mylar, Mylar, epoxy, water glass, or zero-gel.

15. The liquid gas storage container of claim 13, further comprising a skirt disposed along a sidewall of the insulation base, wherein the first insulation layer is disposed within the insulation volume and around the skirt.

16. The liquid gas storage container of claim 15, further comprising one or more anchors mechanically coupled to the skirt.

17. The liquid gas storage container of claim 16, wherein the first insulation sub-layer comprises a load-bearing insulation.

18. The liquid gas storage container of claim 17, wherein the first insulation sub-layer comprises a load-bearing foam comprising a closed-cell foam.

19. The liquid gas storage container of claim 13, further comprising an interleaving layer disposed between the first insulation sub-layer and a second insulation sub-layer.

20. The liquid gas storage container of claim 13, further comprising a protective layer disposed on the first insulation sub-layer.
